(19) United States
(12) Patent Application Publication
(10) Pub. No.: US 2024/0299228 A1
(43) Pub. Date: Sep. 12, 2024

(54) MASSAGE DEVICE INCLUDING SAFETY SENSOR

(71) Applicant: BODYFRIEND CO., LTD., Seoul (KR)

(72) Inventors: Han Il KIM, Seoul (KR); Deok Hyun KONG, Seoul (KR)

(21) Appl. No.: 18/276,037

(22) PCT Filed: Jan. 27, 2022
(86) PCT No.: PCT/KR2022/001417

§ 371 Date: Aug. 6, 2023

(30) Foreign Application Priority Data
Feb. 8, 2021 (KR) 10-2021-0017727
Apr. 16, 2021 (KR) 10-2021-0050115

(51) Int. Cl. A61G 15/00; A61H 9/00

(52) U.S. Cl. CPC A61G 15/007; A61H 9/0078; A61G 2203/30

(57) ABSTRACT

Provided is a massage device including: a body massage unit which massages the back or thigh of a user and includes a receiving portion of a leg massage unit for receiving the leg massage unit; a full-length box which supports the body massage unit and includes a power supply unit and a control unit; and the leg massage unit which massages the legs of the user and rotates around a rotary shaft with respect to the body massage unit, wherein the receiving portion of the leg massage unit includes a first detection sensor, wherein the first detection sensor is arranged toward the leg massage unit and detects whether there is an object in the receiving portion of the leg massage unit, the leg massage unit includes a posture sensor for measuring an angle between the leg massage unit and a seat portion, and the control unit controls the operations of the body massage unit and the leg massage unit.

### TECHNICAL FIELD

The present invention relates to a massage device including a safety sensor or an operating method of the massage device, and more specifically, to a massage device or an operating method of the massage device for preventing an object or a person from getting caught between components included in the massage device.

### BACKGROUND ART

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released. A “massage device” refers to any type of an apparatus, a device, or equipment that performs a massage through a mechanical device without a massager.

As the massage device provides various massage functions, the configuration of the massage device has become complicated, and movements of the massage device have also diversified. Accordingly, there have been instances where a person who is receiving a massage, an infant, or a pet gets caught between the components of the massage device. Therefore, manufacturers of massage devices arrange a plurality of sensors in appropriate positions to prevent accidents in advance.

### DISCLOSURE

### Technical Problem

Recently, there have been incidents where people have been injured or killed due to accidents involving getting caught in massage devices. So, safety devices are being introduced in massage devices. However, the effectiveness varies depending on the location and the operation of the safety devices. The present invention describes the optimal location and operating method of the safety devices.

### Technical Solution

To accomplish the above-mentioned objects, according to the present invention, there is provided a massage device including: a body massage unit for providing a massage to a user's back or thighs, and including a receiving portion for a leg massage unit to accommodate the leg massage unit therein; an electric box supporting the body massage unit and including a power unit and a control unit; and the leg massage unit providing a massage to the user's legs, and rotating around a rotary shaft relative to the body massage unit, wherein the receiving portion of the leg massage unit includes a first detection sensor, which is positioned to face the leg massage unit to detect whether an object exists in the receiving portion of the leg massage unit, the leg massage unit includes a posture sensor for measuring an angle between the leg massage unit and a seat portion, and the control unit controls operations of the body massage unit and the leg massage unit.

According to the present invention, the massage device further includes a second detection sensor located on the upper surface of the electric box to detect whether an object is placed on the upper surface of the electric box, wherein the first detection sensor includes at least one of an ultrasonic sensor, an infrared sensor, a laser sensor, or an illumination sensor, and the second detection sensor includes a tact switch, a capacitive touch sensor, or a pressure sensor.

According to the present invention, when a signal from the posture sensor indicates that the angle formed between the leg massage unit and the seat portion exceeds a predetermined threshold angle, the control unit controls the first detection sensor to detect an object, and when the signal from the posture sensor indicates that the angle formed between the leg massage unit and the seat portion is less than or equal to the predetermined threshold angle, the control unit controls the first detection sensor not to detect an object.

According to the present invention, when the signal from the posture sensor indicates that the angle formed between the leg massage unit and the seat portion exceeds a predetermined threshold angle and the first detection sensor detects an object, the control unit controls to output an alarm signal and halt the movement of the massage device.

According to the present invention, the massage device further includes a massage device control device for the user to control the massage device, wherein the control unit controls to display the alarm signal on the screen of the massage device control device, and the control unit controls to output an alarm release button on the screen of the massage device control device, and to deactivate buttons other than the alarm release button.

According to the present invention, when the alarm signal is output, the control unit determines whether the first detection sensor has detected an object, when the first detection sensor has not detected an object, the control unit determines whether the alarm release button has been pressed by the user, and when the alarm release button has been pressed by the user, the control unit controls the massage device to resume the movement.

According to the present invention, when the alarm release button is pressed by the user, the control unit controls to reactivate the other buttons on the screen of the massage device control device.

According to the present invention, when the signal from the posture sensor indicates that the angle between the leg massage unit and the seat portion exceeds the predetermined threshold angle and the first detection sensor detects an object, the control unit controls the leg massage unit to move parallel to the ground.

According to the present invention, when the second detection sensor detects an object on the upper surface of the electric box, the control unit controls the massage device to stop the movement.

According to the present invention, the massage device further includes a massage device control device for the user to control the massage device, wherein the control unit controls to display the alarm signal on the screen of the massage device control device, and the control unit controls to display the alarm release button on the screen of the massage device control device and controls to deactivate other buttons other than the alarm release button.

According to the present invention, when the alarm signal is output, the control unit determines whether both the first and second detection sensors have detected an object, when neither the first sensor nor the second detection sensor has detected an object, the control unit determines whether the alarm release button has been pressed by the user, and when the alarm release button has been pressed by the user, the control unit controls the massage device to resume the movement.

According to the present invention, when the alarm release button is pressed by the user, the control unit controls to reactivate the other buttons on the screen of the massage device control device.

In addition, a program for implementing an operating method of the massage device can be recorded in a computer-readable recording medium.

### Advantageous Effect

The massage device according to an embodiment of the present invention can prevent the massage device from moving in a state in which an object is located near the massage device. Therefore, the massage device can significantly reduce accidents of an object or a person being caught to the massage device.

### DESCRIPTION OF DRAWINGS

FIG. 1 is a view for depicting a massage device according to one embodiment of the present invention.

FIG. 2 is a view for depicting a main frame according to one embodiment of the present invention.

FIG. 3 is a view illustrating a massage device according to one embodiment of the present invention.

FIG. 4 is a view illustrating an external device that can communicate with the massage device according to one embodiment of the present invention.

FIG. 5 is a side view of the massage device according to one embodiment of the present invention.

FIG. 6 is a perspective view of the massage device with a leg massage unit raised according to one embodiment of the present invention.

FIG. 7 is a front view of the massage device with the leg massage unit raised according to one embodiment of the present invention.

FIG. 8 is a view for depicting the operation of the massage device according to one embodiment of the present invention.

FIG. 9 is a top view illustrating an electric box included in the massage device according to one embodiment of the present invention.

FIG. 10 is a flow chart illustrating an operating method of the massage device according to one embodiment of the present invention.

FIG. 11 is a view illustrating a screen output by the massage device according to one embodiment of the present invention.

### BEST MODE

There is a massage device including: a massage device including: a body massage unit for providing a massage to a user's back or thighs, and including a receiving portion for a leg massage unit to accommodate the leg massage unit therein; an electric box supporting the body massage unit and including a power unit and a control unit; and the leg massage unit providing a massage to the user's legs, and rotating around a rotary shaft relative to the body massage unit, wherein the receiving portion of the leg massage unit includes a first detection sensor, which is positioned to face the leg massage unit to detect whether an object exists in the receiving portion of the leg massage unit, the leg massage unit includes a posture sensor for measuring an angle between the leg massage unit and a seat portion, and the control unit controls operations of the body massage unit and the leg massage unit.

### MODE FOR INVENTION

Advantages and features of the present invention and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention.

Terms used herein will be briefly described, and the disclosed embodiments will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

The singular forms of the components may be understood into the plural forms unless otherwise specifically stated in the context. Furthermore, the plural forms may include singular forms unless otherwise specifically stated in the context.

In the entire specification of the present invention, when a certain part “includes” a certain component, other components are not excluded unless explicitly described otherwise, and other components may in fact be included.

The term, “unit”, used in the present invention means a software element or a hardware element, and the “unit” performs some roles. However, the term, “unit”, is not limited to software or hardware. The “unit” may be configured in an addressable storage medium or may be configured to play one or more processors. Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

According to an embodiment of the present invention, the “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. In some environments, a “processor” may refer to an application specific integrated circuit (ASIC), a programmable logic device (PLD), a field programmable gate array (FPGA), or the like. The term “processor” may refer to a combination of processing devices, such as a combination of a DSP genome and a microprocessor, a combination of a plurality of microprocessors, a combination of one or more microprocessors in combination with a DSP couple core, or a combination of any other such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erase-programmable read-only memory (EPROM ACL), electrically erasable PROM (EEPROM), flash memory, magnetic or optical data storage, registers, and the like. Memory is referred to as being in electronic communication with the processor if the processor can read information from, and/or write information to, the memory. The memory integrated in the processor is in electronic communication with the processor.

In the present specification, an actuator refers to a configuration capable of providing a driving force. For example, the actuator may include a motor, a linear motor, an electronic motor, a DC motor, an AC motor, a linear actuator, an electric actuator, and the like, but is not limited thereto.

In this specification, according to one embodiment, the massage device may refer to a massage device including a body massage unit and a leg massage unit. Furthermore, according to another embodiment, the body massage unit 2100 and the leg massage unit 2300 may exist as separate individual devices (for example, a body massage device and a leg massage device), and the massage device can refer to either the body massage device or the leg massage device.

Hereinafter, embodiments of the present invention will be described in detail with reference to the accompanying drawings so as to be easily carried out by a person skilled in the art to which the present invention pertains. In addition, in order to clearly describe the present invention, portions irrelevant to the description will be omitted.

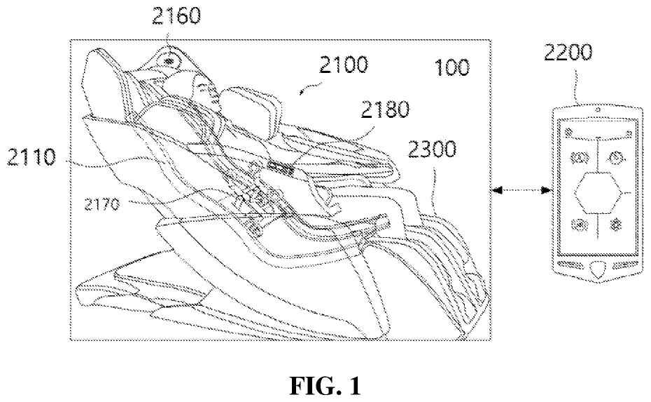

FIG. 1 is a view for depicting a massage device according to an embodiment of the present invention.

The massage device 100 according to an embodiment of the present invention has an area for accommodating at least a portion of the body of a user, and may include a body massage unit 2100 for massaging a user's body, and a leg massage unit 2300 for massaging the user's legs.

The body massage unit 2100 may provide a massage to at least a portion of the body of the user. The body massage unit 2100 may include a massage module 2170, which provides a massage function to at least a portion of the body of the user, an audio output module 2160, which provides any type of audio output to the user, a main frame 2110 which forms the framework of the body massage unit 2100, and a user input unit 2180 which receives any type of input from the user.

The components included in the body massage unit 2100 are just exemplary embodiments, and the body massage unit 2100 may include other various components.

Additionally, the shape and the structure of the massage device 100 illustrated in FIG. 1 are just examples, and various forms of massage device 100 can be included within the scope of the present invention without departing from the scope of the present invention defined by the claims of the present invention.

The body massage unit 2100 can form a space of any shape to accommodate the user. The body massage unit 2100 may have a space with the shape corresponding to the shape of the body of the user. For example, as illustrated in FIG. 1, the body massage unit 2100 can be realized as a seat type that can accommodate the user's whole body or a portion of the body and can support at least a portion of the body of the user. For example, the body massage unit 2100 may include a backrest supporting at least a portion of the user's upper body, and a seat supporting at least a portion of the user's lower body.

A portion of the body massage unit 2100 which contacts the ground may include any material or component (for example, a non-slip pad) for increasing frictional force, and may include wheels for enhancing mobility of the massage device 100.

At least a portion of the body massage unit 2100 can slide. For instance, when the body massage unit 2100 starts a massage, at least a portion of the body massage unit 2100 can slide forward. Additionally, the body massage unit 2100 can tilt backwards. As a result, the body massage unit 2100 can provide a massage while tilted backwards.

According to one embodiment of the present invention, the massage device (100) may include at least one air cell (not shown). The air cell can be located in the user's shoulder area, pelvic area, arm massage unit, leg massage unit (2300), and the like, but is not limited thereto and can be positioned in various parts of the massage device (100).

The massage device 100 may include an air supply unit, which can inflate the air cell by supplying air to the air cell. The air supply unit may be located inside the body massage unit 2100 or may be located in the leg massage unit 2300. In addition, the air supply unit can be located outside the massage device 100.

The leg massage unit 2300 may provide a leg massage to the user. For instance, the leg massage unit 2300 may include a calf massage unit which massages the user's calf and/or a foot massage unit which massages the user's foot.

The leg massage unit 2300 can be adjustable in length according to the user's body characteristics. For example, when a user who is tall uses the massage device 100, it is necessary to extend the length of the leg massage unit 2300 since the user's calves are long. Moreover, when a user who is short uses the massage device 100, it is necessary to reduce the length of the leg massage unit 2300 since the user's calves are short. Accordingly, the leg massage unit 2300 can provide a leg massage tailored to the user's height.

The massage module 2170 can be provided inside the body massage unit 2100 to offer any form of mechanical stimulation to the user accommodated in the body massage unit 2100. As depicted in FIG. 1, the massage module 2170 can move along the main frame 2110 provided inside the body massage unit 2100.

For instance, the main frame 2110 of the body massage unit 2100 can be equipped with a rack gear, and the massage module 2170 can move along this rack gear, providing mechanical stimulation to various parts of the user's body. The massage module 2170 may include a ball massage unit or a roller massage unit, but is not limited thereto.

The main frame 2110 serves as the structural backbone of the internal configuration of the body massage unit 2100 and can be made from materials such as metal or plastic. For example, the main frame 2110 can be implemented using iron, alloy, steel, among others, but is not limited thereto and can be made of various durable materials.

According to an embodiment of the present invention, the massage device 100 may include an audio output module 2160. The audio output module 2160 may be provided in various locations. For example, the audio output module 2160 may include multiple output units such as a top audio output unit placed on the top of the seat portion in contact with the user, a front audio output unit coupled to the front end of the arm massage unit 1200 on both sides of the seat portion, and/or a rear audio output unit coupled to the rear end of the arm massage unit 1200, but is not limited thereto. In this case, the audio output module 2160 can provide stereophonic sound such as 5.1 channels, but is not limited thereto.

According to an embodiment of the present invention, the user can control the massage device 100 using a massage device control device 2200. The massage device control device 2200 can be connected to the massage device 100 through wired communication and/or wireless communication.

The massage device control device 2000 may include at least one user device (personal device), such as a remote controller, a cellular phone, and a PDA (Personal Digital Assistant), but is not limited thereto, and may include various electronic devices that can be connected to the massage device 100 through wired or wireless communication.

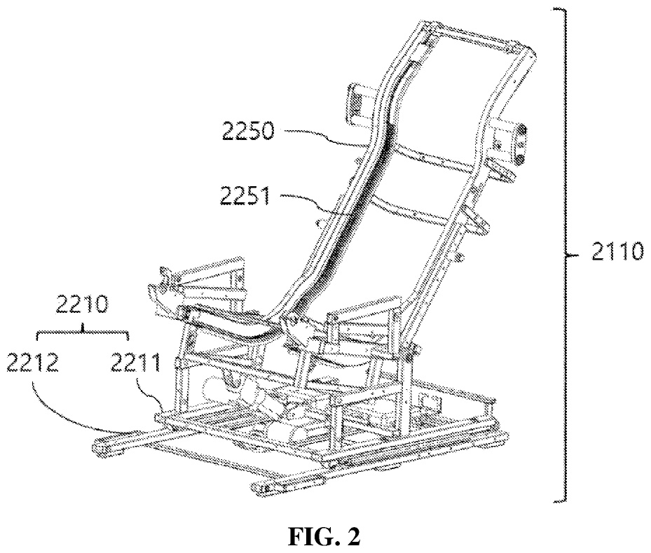

FIG. 2 is a view for depicting a massage device according to an embodiment of the present invention.

According to an embodiment of the present invention, the main frame 2110 may include an upper frame 2250, on which a massage module 2170 is equipped, and a base frame 2210 that supports the upper frame 2250.

A rack gear 2251 may be provided on at least a portion of the upper frame 2250. The rack gear 2251 may include a plurality of teeth and a plurality of valleys, as a member guiding the vertical movement of the massage module 2170.

According to an embodiment of the present invention, the rack gears 2251 may be provided on both sides of the upper frame 2250 to face each other, and the massage module 2170 may move along the rack gear 2251.

In FIG. 2, the rack gears 2251 are formed in the vertical direction, but are not limited thereto. The rack gear 2251 may include a front-rear direction rack gear and a vertical rack gear. The front-rear direction in the present invention means the direction heading towards the user from the massage module 100 or heading towards the massage module 100 from the user, and may means the Z-axis direction based on FIG. 2.

The massage module 2170 may include a gear that meshes with the rack gear 2251. More specifically, the massage module 2170 may include gears that respectively mesh with a front-rear direction rack gear and a vertical rack gear. By the rotation of the gear by an actuator equipped on the massage module 2170, the massage module 2170 can move forward, backward, upward, or downward.

As the massage module 2170 moves forward, the intensity of the massage may increase. Additionally, as the massage module 2170 moves backward, the intensity of the massage may decrease.

The rack gear 2251 may be made of metal or plastic materials. For example, the rack gear 2251 may be made of iron, steel, alloy, reinforced plastic, melamine resin, phenolic resin, etc., but is not limited thereto.

The upper frame 2250 may be realized in various shapes. For instance, the upper frame 2250 may be classified into an S-frame, an L-frame, an S&L frame, a double S&L frame according to shapes, but is not limited thereto.

The S-frame refers to a frame where at least a portion of the upper frame 2250 includes a curved shape like “S”. The L-frame means a frame that includes a bent shape like “L” in at least a portion of the upper frame 2250. The S&L frame means a frame including an “S”-shaped curved form and an “L”-shaped bent form. The double S&L frame means a frame including an “L”-shaped bent form and two “S”-shaped curved forms.

The base frame 2210 means a part which supports the upper frame 2250 and contacts the ground or the installation surface of the massage device 100. The base frame 2210 may include an upper base frame 2211 and a lower base frame 2212.

The upper base frame 2211 may support the upper frame 2250, and the lower base frame 2212 may come into contact with the ground or the installation surface of the massage device 100. Additionally, the upper base frame 2211 can be positioned to contact the lower base frame 2212.

According to an embodiment of the present invention, the upper base frame 2211 can move along the lower base frame 2212. For instance, the upper base frame 2211 can slide forwards or backwards along the lower base frame 2212. In this case, the upper frame 2250 is connected to the upper base frame 2211, can move according to the movement of the upper base frame 2211.

For example, when the upper base frame 2211 moves forward, the upper frame 2250 can also move forward, and when the upper base frame 2211 moves backward, the upper frame 2250 can also move backward. As a result, the sliding movement of the body massage unit 2100 can be permitted.

In detail, to allow the movement of the upper base frame 2211, a moving wheel may be provided on the underside of the upper base frame 2211. Additionally, a guide member, which can guide the moving wheel, may be provided on the top of the lower base frame 2212. The moving wheel provided on the upper base frame 2211 can move along the guide member provided on the lower base frame 2212, allowing for the forward or backward movement of the upper base frame 2211.

According to another embodiment of the present invention, the massage device 100 may not provide a sliding function, and in this case, the base frame 2210 may not be separated into upper and lower frames.

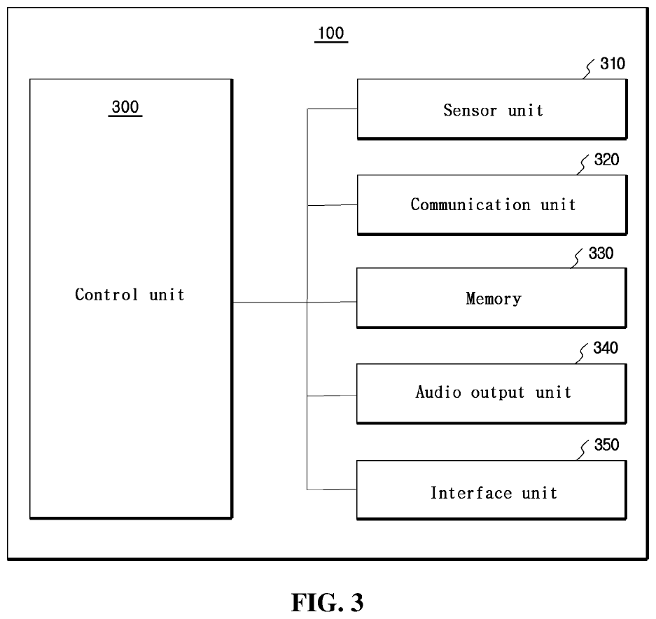

FIG. 3 is a view for depicting a detailed configuration of a massage device according to an embodiment of the present invention.

According to an embodiment of the present invention, the massage device 100 may include at least one among a control unit 300, a sensor unit 310, a communication unit 320, memory 330, an audio output unit 340, and an input unit 350. The control unit 300 may include at least one processor and memory. The at least one processor can execute instructions stored in memory.

The control unit 300 can control the operation of the massage device 100. The control unit 300 may include one processor and may include multiple processors. If the control unit 300 includes multiple processors, at least some of the multiple processors can be located at physically separated distances. Furthermore, the massage device 100 is not limited thereto and can be realized in various ways.

According to an embodiment of the present invention, the control unit 300 may control the operation of the massage device 100. For instance, the massage device 100 may include a plurality of actuators, and the control unit 300 can control the operation of the massage device 100 by controlling the operation of the plurality of actuators. For example, the massage device 100 may include at least one among a driving unit that moves the armrest frame support, a massage module moving actuator, at least one actuator included in the massage module 100, a back angle actuator, a leg angle actuator, a foot massage actuator, a leg length adjustment actuator, and a sliding actuator. The control unit 300 controls them to control the operation of the massage device 100.

The massage module moving actuator is an actuator capable of moving the massage module 2170 vertically, so the massage module 2170 can move along the rack gear by the operation of the massage module moving actuator.

The back angle actuator is an actuator that adjusts the angle of a part of the massage device 100 contacting with the user's back, and the back angle of the massage device 100 can be adjusted by the operation of the back angle actuator.

The leg angle actuator is an actuator to adjust the angle of the leg massage unit 2300 of the massage device 100, and the angle between the leg massage unit 2300 and the body massage unit 2100 can be adjusted by the operation of the leg angle actuator.

The foot massage actuator represents an actuator that operates the foot massage module included in the leg massage unit 2300. The massage device 100 can provide a foot massage to the user using the foot massage actuator.

The massage module 2170 may include at least one actuator, and the control unit 300 can provide various massage actions by operating at least one actuator. For instance, the control unit 300, by operating at least one actuator included in the massage module 2170, can provide massages such as tapping and kneading, but is not limited thereto and can provide various other massage actions.

The leg length adjustment actuator represents an actuator adjusting the length of the leg massage unit 2300. For example, the control unit 300 can adjust the length of the leg massage unit 2300 to fit the user using the leg length adjustment actuator, and as a result, the user can receive a massage suited to the body shape.

The sliding actuator enables the sliding motion of the massage device 100. For instance, a horizontal base upper frame can move forward or backward due to the operation of the sliding actuator, so that the upper frame connected to the horizontal base upper frame also moves forward or backward.

The memory 330 may be included in the control unit 300 or located outside the control unit 300. The memory 330 can store various pieces of information related to the massage device 100. For example, the memory 330 may contain massage control information and personal authentication information, but is not limited thereto.

The memory 330 can be realized through a non-volatile storage medium, which can continuously store arbitrary data. For example, the memory 330 may include storage devices based on a disk, an optical disk, a magneto-optical storage device, a flash memory and/or a battery-backed memory, and is not limited thereto.

The memory 330 is a primary storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 330 can be operated by the control unit 300.

The massage device 100 may include a sensor unit 310. The sensor unit 310 can acquire various information using at least one sensor. The sensor unit 310 can be equipped with sensors using measurement means such as pressure, potential, and optics. For example, the sensor unit may include a pressure sensor, an infrared sensor, an LED sensor, a touch sensor, an electrode sensor, an air pressure measurement sensor, and is not limited thereto.

The sensor unit 310 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, but is not limited thereto, and may include various biometric information.

According to another embodiment of the present invention, the massage device 100 can detect a contact area and/or contact position with the user through the sensors. Moreover, the massage device 100 can provide a customized massage based on the information acquired through the sensors. Moreover, the massage device 100 may include a communication unit. The communication unit of the massage device 100 may receive a signal from an external device. The control unit 300 can process the received signal and obtain a result signal. The communication unit can output the result signal to the external device.

The communication unit 320 can communicate with an internal module of the massage device 100, an external massage device and/or a user terminal via any type of network. The communication unit may include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit may include a short-range communication module, which allows data transmission and reception with any device/terminal located in close range. For short-range communication technology, there are Bluetooth, RFID (Radio Frequency Identification), IrDA (infrared Data Association), UWB (Ultra-Wideband), ZigBee, and the like, and the communication technologies are not limited thereto.

Furthermore, the massage device 100 may further include an input unit 350 or an output unit. The massage device 100 may receive an input from the user using the input unit 350. Additionally, the massage device 100 can output the processing result of the control unit 300 to the output unit. The input unit 350 and the output unit may be implemented as one device by being integrated. For example, a touch screen can output an image as soon as receiving an input from the user.

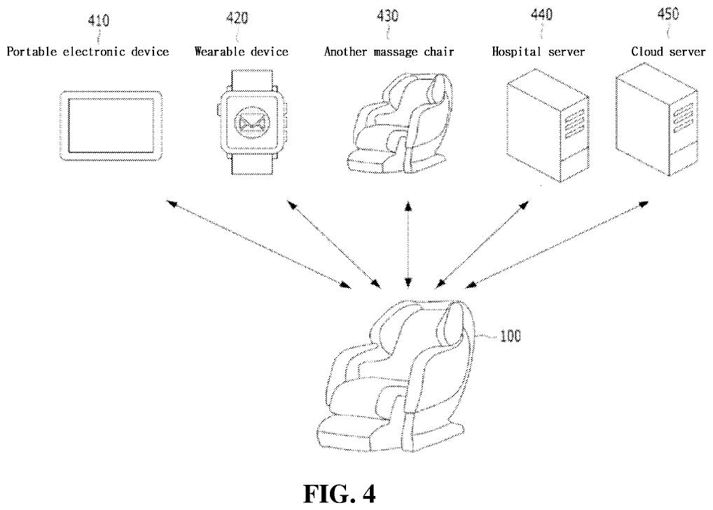

Specifically, the input unit 350 can receive commands related to the operation control of the massage device 100 from the user, and the input unit 350 may be realized in various forms. For example, the input unit 350 can be equipped in the body massage unit 2100, and can be equipped in the leg massage unit 2300, but is not limited thereto. In addition, the input unit 350 may include a user input unit 2180 of FIG. 1, a massage device control device 2000, or various external devices to be described in FIG. 4.

The massage device 100 can acquire various commands from the user through the input unit 350. For example, the massage device 100 can receive any command for selection of the massage module, selection of massage type, selection of massage intensity, selection of massage time, selection of the massage area, selection related to the position and operation of the body massage unit 2100, on-off selection for the power of the massage device 100, selection regarding the operation of the heat function, selection related to music playback, and more, but it is not limited thereto.

The massage device 100 can provide an interface for selecting the massage mode. For example, the input unit 350 or output unit may include a massage device control device 2000. Various modes of medical massage related to body improvement can be listed through the massage device control device 2000.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

According to another embodiment of the present invention, the input unit 350 can be equipped with buttons in the form of a hot key and/or selection buttons to execute direction selection, cancellation, and input, depending on pre-set user settings or its own pre-set functions.

The input unit 350 can be realized as a touchscreen, a keypad, a dome switch, a touch pad (pressure/static), a jog wheel, a jog switch, and others, but is not limited thereto. Moreover, the input unit 350 can acquire commands through the user's speech based on voice recognition technology.

According to an embodiment of the present invention, the output unit may include a display for displaying the operating situation of the massage device 100 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output unit may include an audio output unit 340. The audio output unit 340 of FIG. 3 may include the audio output module 2160 of FIG. 1. The audio output unit 340 can provide any type of audio output to the user. For example, the audio output unit 340 can provide brain stimulation to the user by outputting music and/or binaural beats optimized for the massage pattern provided by the massage device 100. The audio output unit 340 can output an acoustic signal received through a network (not illustrated) or stored in an internal/external storage medium (not illustrated). For instance, the audio output unit 340 can output music controlled by the user's terminal through a network connection (e.g., a Bluetooth connection) with the user's terminal. In addition, the audio output unit 340 can output any type of acoustic signal related to the operation of the massage device 100.

A person of ordinary skill in the technical field to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium may include a computer-readable storage medium and a computer-readable transmission medium.

The computer-readable storage medium includes volatile and non-volatile, transitory and non-transitory, removable and non-removable media realized by any method or technology for storing information such as computer-readable instructions, data structures, program modules, or other data. The computer-readable storage medium includes RAMs, ROMs, EEPROMs, flash memories or other memory technology, CD-ROMs, digital video disks (DVD) or other optical disk storage devices, magnetic cassettes, magnetic tape, magnetic disk storage devices or other magnetic storage devices, or any other medium that can be accessed by a computer and used to store desired information, but is not limited thereto.

FIG. 4 is a view illustrating an external device that can communicate with a massage device according to an embodiment of the present invention.

The massage device 100 can transmit and receive various data through wired or wireless communication with the external device.

The external device may include a portable electronic device 410 such as an AI speaker, a tablet, or a smartphone. The portable electronic device 410 may be dedicated to the massage device 100 or may be a general-purpose portable electronic device. In addition, the external device may include a wearable device 420 such as a smartwatch or a smart band. The external device may include another massage device 430 that the user is not currently using. The external device may include a hospital server 440. The external device may include a personal health record (PHR) server. Additionally, the external device may include a cloud server 450. The external device may include a medical measurement device such as an electronic scale, a blood glucose meter, or a blood pressure meter.

In this invention, examples of the external device have been described, but any device that can communicate with the massage device 100 wirelessly or by wire and exchange information may all be regarded as external devices.

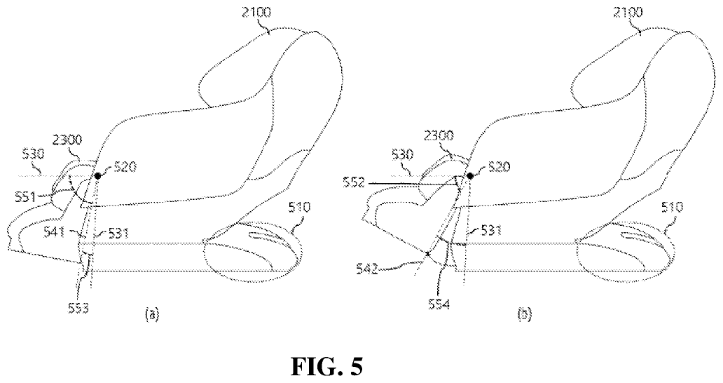

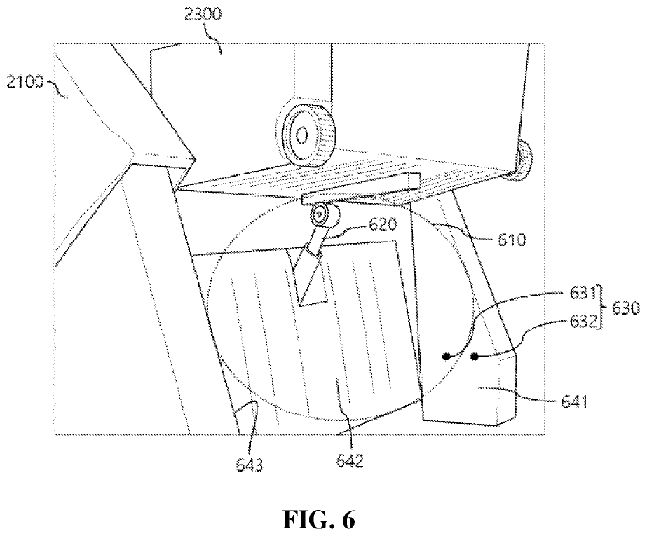

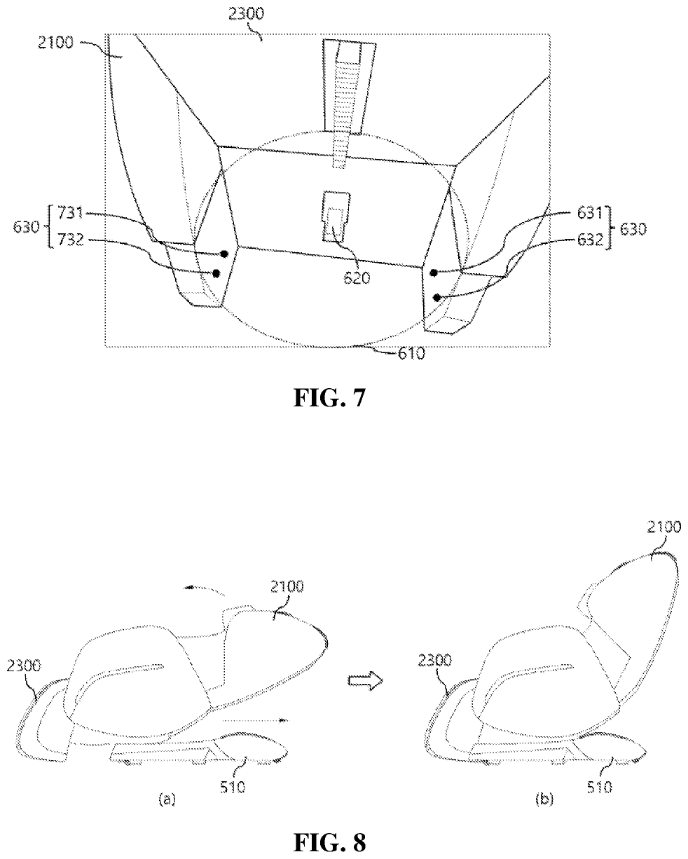

FIG. 5 is a side view of the massage device according to one embodiment of the present invention, FIG. 6 is a perspective view of the massage device with a leg massage unit raised according to one embodiment of the present invention, and FIG. 7 is a front view of the massage device with the leg massage unit raised according to one embodiment of the present invention.

The massage device in FIG. 7 is the massage device in FIG. 6 viewed from a different angle. Additionally, FIG. 7 illustrates a more elevated state of the leg massage unit 2300 in FIG. 6.

Referring to FIGS. 5 through 7, the massage device 100 may include a body massage unit 2100. The body massage unit 2100 may be designed to massage the user's back or thighs. Also, the body massage unit 2100 may comprise a receiving portion 610 for housing the leg massage unit 2300. The body massage unit 2100 has already been described, so repetitive description of the body massage unit will be omitted.

For convenience of the description in the present invention, it is described that the body massage unit 2100 includes an arm massage unit. The arm massage units are respectively located on both sides of the body massage unit 2100 to massage the user's arms.

The receiving portion 610 may be a space formed by three sides of the housing of the body massage unit 2100. The receiving portion 610 may be the space formed by a right side 641 of a left arm massage unit, a left side 643 of a right massage unit, and a front face 642 of the body massage unit 210.

The massage device 100 may include an electric box 510. The electric box 510 can be located at the rear bottom of the massage device 100. The electric box 510 can be connected to the base frame 2210. Moreover, the electric box 510 may be a type of the housing to cover the base frame 2210. The electric box 510 can support the body massage unit 2100. Additionally, a power unit and a control unit 300 may be included inside the electric box 510. The control unit 300 may be a mainboard. The control unit 300 may be configured to control the operations of the body massage unit and the leg massage unit.

The massage device 100 may include a leg massage unit 2300. The leg massage unit 2300 can provide a massage to the user's legs. In addition, the leg massage unit 2300 can rotate around a rotary shaft 520 relative to the body massage unit. Although the rotary shaft 520 is shown in FIG. 5, the rotary shaft 520 may not be seen from the outside since being located inside the housing. The rotary shaft may be coupled to the main frame 2110.

FIG. 6 illustrates a portion of the body massage unit 2100. The body massage unit 2100 illustrated in FIG. 6 may be an arm massage unit. The body massage unit may include an arm massage unit designed to massage the user's arm. Additionally, the body massage unit may include a seat portion for the user to sit on.

Referring to FIG. 6, the leg angle actuator included in the body massage unit 2100 can adjust the protrusion degree of a rod 620 from the body massage unit 2100. The leg massage unit 2300 can ascend or descend depending on the protrusion degree of the rod 620 from the body massage unit 2100.

For instance, when the rod 620 of FIG. 6 protrudes less from the body massage unit 2100, the leg massage unit 2300 may descend. It may be in the same state as FIG. 5(a). At this time, an angle 553 between a direction 541 of the leg massage unit and a direction 531 of the front side 642 of the seat portion may be relatively small. Here, the seat portion is included in the body massage unit 2100. The seat portion might refer to the portion where the user sits. In addition, an angle 551 between the direction 541 of the leg massage unit and a direction 530 parallel to the ground may be relatively large. The direction 541 of the leg massage unit can be perpendicular to the left-right direction from the rear of the leg massage unit 2300. The direction 541 of the leg massage unit may be the direction toward the foot from the knee when the user sits on the massage device 100. The direction 541 of the leg massage unit is a value changing depending on the angle adjustment of the leg massage unit 2300, and may be a direction set based on a direction parallel or perpendicular to the ground. The direction 531 of the front side 642 of the seat portion may be perpendicular to the left-right direction from the front side 642 of the seat portion. Here, the left-right direction may refer to the left-right direction when the user sits on the massage device 100. The direction 531 of the front side 642 of the seat portion may be a fixed value, and may be a direction set based on a direction parallel or perpendicular to the ground. The massage device 100 can acquire the direction parallel or perpendicular to the ground using a gyro sensor or an acceleration sensor.

Moreover, when the rod 620 of FIG. 6 protrudes more from the body massage unit 2100, the leg massage unit 2300 may ascend. It may be in the same state as FIG. 5(a). At this time, an angle 553 between the direction 541 of the leg massage unit and the direction 531 of the front side 642 of the seat portion may be relatively large. Furthermore, an angle 552 between a direction 542 of the leg massage unit and the direction 530 parallel to the ground may be relatively small.

When the leg massage unit 2300 ascends, as shown in FIG. 5(b), a space may be formed between the body massage unit 2100 and the leg massage unit 2300. When an object, an animal, or a person is situated between the body massage unit 2100 and the leg massage unit 2300, if the leg massage unit 2300 descends again, an accident that the object, the animal, or the person is trapped between the body massage unit 2100 and the leg massage unit 2300 may occur due to the weight of the leg massage unit 2300. In order to prevent such an accident, a first detection sensor can be utilized.

The massage device 100 may include a first detection sensor 630. The receiving portion 610 of the leg massage unit may include the first detection sensor 630. More specifically, the first detection sensor 630 may be included in the housing of the body massage unit 2100. Even more specifically, the first detection sensor 630 may be included on the left side 643 of the right arm massage unit and the right side 641 of the left arm massage unit. Additionally, the first detection sensor 630 may be included in the arm massage unit within the body massage unit 2100. The first detection sensor 630 may be positioned in the arm massage unit facing the leg massage unit 2300. The first detection sensor 630 may be positioned facing the leg massage unit 2300. The first detection sensor 630 can detect whether there is an object in the receiving portion 610 of the leg massage unit. In the present invention, the object may be an item, a person, or an animal.

The first detection sensor 630 may include at least one of an ultrasonic sensor, an infrared sensor, a laser sensor, or an illuminance sensor. However, the present invention is not limited thereto, and any sensor capable of detecting the presence of an object can be used. The arrangement of the first detection sensor 630 facing the leg massage unit 2300 means that the first detection sensor 630 irradiates ultrasonic, infrared, or laser radiation towards the receiving portion 610 of the leg massage unit. Additionally, the first detection sensor 630 can receive the irradiated ultrasonic wave, infrared ray, or laser. Based on the ultrasonic wave, infrared ray, or laser received by the first detection sensor 630, the massage device 100 can determine whether there is an object between the body massage unit 2100 and the leg massage unit 2300. Alternatively, the massage device can determine whether there is an object in the receiving portion 610 of the leg massage unit.

Referring to FIG. 6, the first detection sensor 630 may be placed on the fixed body massage unit 2100. Since the first detection sensor 630 is installed on the body massage unit 2100 rather than the leg massage unit 2300, the first detection sensor 630 can detect whether there is an object in the same position. If the first detection sensor 630 is installed on the leg massage unit 2300 rotating around the rotary shaft, the area in which the first detection sensor 630 detects an object may change as the leg massage unit 2300 moves. The change in the area detecting the object may mean a reduction of stability. For example, when the leg massage unit 2300 moves, the movement of the leg massage unit 2300 may differ for each massage device 100 due to mechanical errors. In this case, the first detection sensor 630 may detect the presence of an object in an area different from a designer's intention. That is, the massage device 100 may not detect the presence of an object in a specific space that the designer intended. Therefore, it may cause a problem in connection with safety of the massage device 100. The massage device 100 according to the present invention has the first detection sensor 630 or a second detection sensor 910 on a fixed position to detect whether an object is located in the same space. Therefore, the safety of the massage device 100 can be greatly improved.

Moreover, the first detection sensor 630 is located on the right side 641 of the left arm massage unit and the left side 643 of the right arm massage unit, and is arranged to face the leg massage unit 2300 from the arm massage unit. Therefore, the first detection sensor 630 can directly detect whether an object is located in the space created when the leg massage unit 2300 is lifted. If the first detection sensor 630 is located elsewhere, the first detection sensor 630 may detect when an object is entering the space, but may not directly detect if an object is located in the space.

Referring to FIG. 6, there may be multiple first detection sensors 630. The first detection sensors 630 may include a 1-1 sensor 631 and a 1-2 sensor 632. If there are multiple first sensors 630, they can detect whether there is an object in a wide range of the leg massage unit receiving portion 610. Therefore, the massage device 100 can be safer.

Referring to FIG. 7, the 1-1 sensor 631 and the 1-2 sensor 632 included in the first detection sensor 630 may each exist as a pair. More specifically, the 1-1 sensor 631 and a 1-3 sensor 731 may exist as a pair. The 1-1 sensor 631 may be a transmitter, and the 1-3 sensor 731 may be a receiver. Conversely, the 1-1 sensor 631 may be a receiver, and the 1-3 sensor 731 may be a transmitter. The 1-1 sensor 631 and the 1-3 sensor 731 can be aligned. Therefore, when the 1-1 sensor 631 emits infrared rays or ultrasound waves, the 1-3 sensor 731 can receive the emitted infrared rays or ultrasound waves. Conversely, when the 1-3 sensor 731 emits infrared rays or ultrasound waves, the 1-1 sensor 631 can receive the emitted infrared rays or ultrasound waves. If there is an object between the 1-1 sensor 631 and the 1-3 sensor 731, the receiving part of the 1-1 sensor 631 and the 1-3 sensor 731 cannot receive the infrared rays or ultrasound waves, so the massage device 100 can determine that there is an object between the body massage unit 2100 and the leg massage unit 2300. Alternatively, the massage device 100 can determine that there is an object in the receiving portion 610 of the leg massage unit. However, the present invention is not limited thereto, and both the 1-1 sensor 631 and the 1-3 sensor 731 may include both a transmitter and a receiver.

When the 1-1 sensor 631 and the 1-2 sensor 632 are located on the left side of the body massage unit 2100, the 1-3 sensor 731 and a 1-4 sensor 732 can be located on the right side of the body massage unit 2100.

Referring to FIG. 7, the 1-2 sensor 632 and the 1-4 sensor 732 can exist as a pair. The description for the 1-2 sensor 632 and the 1-4 sensor 732 is redundant with the description for the 1-1 sensor 631 and the 1-3 sensor 731, so the description for the 1-2 sensor 632 and the 1-4 sensor will be omitted.

Referring to FIGS. 6 and 7, the 1-1 sensor 631 and the 1-2 sensor 632 are arranged parallel to the ground. However, the present invention is not limited thereto. The 1-1 sensor 631 and the 1-2 sensor 632 can be arranged vertically to the ground. The 1-3 sensor 731 and the 1-4 sensor 732 can be located corresponding to the 1-1 sensor 631 and the 1-2 sensor 632, respectively. In addition, more than two first sensors 630 may be provided.

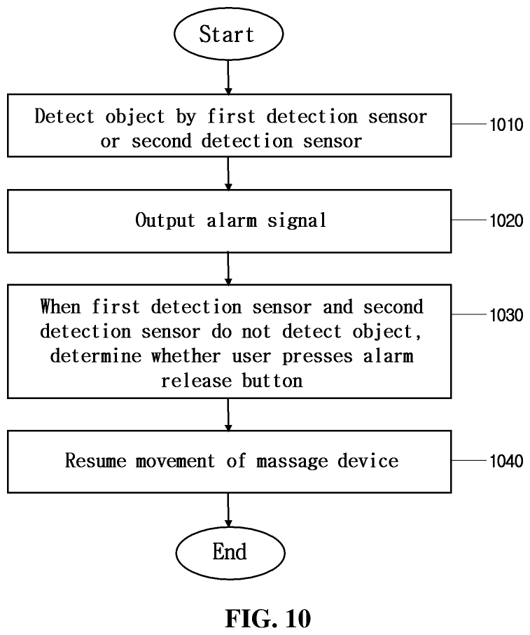

The first sensor 630 cannot differentiate whether its detected subject is the leg massage unit 2300 or another object. Therefore, the massage device 100 can determine whether the object recognized by the first sensor 630 is the leg massage unit 2300 or another object based on the angle formed between the leg massage unit 2300 and the front side 642 of the seat portion. For example, when the angle between the leg massage unit 2300 and the front side 642 of the seat portion is less than or equal to a predetermined threshold angle, the massage device 100 can determine the object detected by the first sensor 630 as the leg massage unit 2300. Accordingly, when the angle between the leg massage unit 2300 and the front side 642 of the seat portion is less than or equal to a predetermined threshold angle, the massage device 100 can deactivate the first sensor 630 or ignore the signal from the first sensor 630. Conversely, when the angle between the leg massage unit 2300 and the front side 642 of the seat portion exceeds the predetermined threshold angle, the massage device 100 can determine that the object recognized by the first sensor 630 is not the leg massage unit 2300. Therefore, when the angle between the leg massage unit 2300 and the front side 642 of the seat portion exceeds the predetermined threshold angle, the massage device 100 can generate an alarm based on the signal from the first sensor 630. The alarm can indicate the presence of an object between the leg massage unit 2300 and the seat portion or ask to remove the object between them. Such a process will be described in conjunction with FIG. 10.

FIGS. 6 and 7 disclose two pairs of the first sensor 630, but they are not limited thereto, and five or more first sensors 630 may be provided.

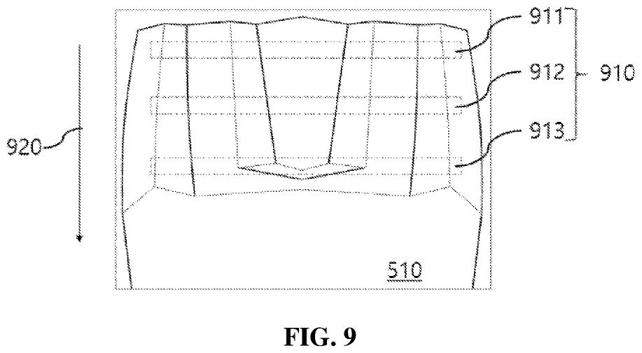

Referring to FIG. 5, the massage device 100 may include an electric box 510. The massage device 100 may include the second sensor 910. The second sensor 910 is located on the upper surface of the electric box and can detect whether an object is placed on the upper surface of the electric box. The second sensor 910 may include at least one of a capacitive touch sensor, a resistive touch sensor, a pressure sensor, and a switch. Referring to FIGS. 8 and 9, the second sensor 910 will be described.

FIG. 8 is a view illustrating the operation of the massage device according to an embodiment of the present invention.

FIG. 8(a) illustrates a state in which the body massaging unit 2100 of the massage device 100 is tilted backward. As illustrated in FIG. 8(a), when the body massaging unit 2100 is tilted backward, the body massaging unit 2100 can perform the following actions to stand up.

The body massaging unit 2100 can move backward with respect to the electric box 510. At the same time, the body massaging unit 2100 can be lifted up forward. If there is an object at the rear of the massage device 100, the body massaging unit 2100 may damage the object located at the rear while tilting backward. Therefore, when the body massaging unit 2100 of the massage device 100 is tilted backward, the body massaging unit 2100 can move forward with respect to the electric box 510. Conversely, when the body massaging unit 2100 of the massage device 100 is lifted up forward, the body massaging unit 2100 can move backward with respect to the electric box 510.

When the body massaging unit 2100 is lifted up forward and there is an object, a person, or an animal positioned within the electric box 510, the object, the person, or the animal may be caught between the body massaging unit 2100 and the electric box 510. Furthermore, if the object, the person, or the animal is caught between the body massaging unit 2100 and the electric box 510, the massage device 100, the object, the person, or the animal may be injured. Therefore, the massage device according to the present invention may include the second detection sensor 910 at the top of the electric box 510.

FIG. 9 is a top view illustrating an electric box included in the massage device according to one embodiment of the present invention.

As described above, the second detection sensor 910 may include at least one of a capacitive touch sensor, a pressure-sensitive touch sensor, a pressure sensor, and a switch. The second detection sensor 910 can be attached to the inner surface of the electric box 510. Moreover, the second detection sensor 910 can detect when an object touches the outer surface of the electric box 510. If the second detection sensor 910 is a capacitive touch sensor and a conductive object touches the electric box 510, the second detection sensor 910 can send a signal indicating the presence of the object on the electric box 510 to the control unit 300. Furthermore, if the second detection sensor 910 is a pressure-sensitive touch sensor, a pressure sensor, or a switch and an object presses the electric box 510, the second detection sensor 910 is pressed, and sends a signal indicating the presence of an object on the electric box 510 to the control unit 300. The pressure-sensitive touch sensor has an advantage of being fast and responsive even if the object does not directly touch the electric box 510. The pressure-sensitive touch sensor, the pressure sensor, and the switch have an advantage of operating even when the object is non-conductive. Therefore, the second detection sensor 910 can comprehensively utilize at least one of a capacitive touch sensor, a pressure-sensitive touch sensor, a pressure sensor, and a switch. Here, the switch may refer to a tact switch.

In FIG. 9, the forward direction 920 may refer to the direction facing forward when the user sits on the massage device 100. The second sensor 910 may have an elongated shape extending horizontally. Furthermore, a plurality of the second sensors 910 may be provided. For example, the second sensor 910 may include a 2-1 sensor 911, a 2-2 sensor 912, and a 2-3 sensor 913. The 2-1 sensor 911, the 2-2 sensor 912, and the 2-3 sensor 913 may be of the same type or may be of different types. The 2-1 sensor 911, the 2-2 sensor 912, and the 2-3 sensor 913 can be arranged in parallel.

However, the present invention is not limited thereto, and the 2-1 sensor 911, the 2-2 sensor 912, and the 2-3 sensor 913 may also have an elongated shape extending vertically. Furthermore, the 2-1 sensor 911, the 2-2 sensor 912, and the 2-3 sensor 913 may be parallel to each other or be oriented perpendicularly.

FIG. 10 is a flow chart illustrating an operating method of the massage device according to one embodiment of the present invention.

The leg massage unit 2300 may include a posture sensor for measuring the status of the leg massage unit. The posture sensor can measure an angle between the leg massage unit and the seat portion. The status of the leg massage unit might refer to the angle formed between the leg massage unit 2300 and the seat portion. More specifically, the status of the leg massage unit can refer to the angle formed between the direction of the leg massage unit 2300 and the direction of the front side 642 of the seat portion. The leg massage unit 2300 may include a control board for controlling an actuator associated with the leg massage unit. The control board within the leg massage unit may also include a posture sensor. The posture sensor may be one of a magnetic sensor, a gyro sensor, or an acceleration sensor.

Referring to FIG. 5, the leg massage unit 2300 can rotate relative to the body massage unit 2100. FIG. 5(a) illustrates a basic state of the massage device 100. In this instance, the user's legs may be in a bent position. As illustrated in FIG. 5(a), the orientation of the leg massage unit 2300 can be almost perpendicular to the direction parallel to the ground 530. The posture of the massage device 100 as illustrated in FIG. 5(a) may be referred to as the basic state.

Furthermore, FIG. 5(b) illustrates a state where the leg massage unit 2300 is raised. At this time, the user's legs may be in a stretched position. An angle 554 between the direction 542 of the leg massage unit 2300 in FIG. 5(b) and the direction 531 of the front side 642 of the seat portion may be greater than the angle 553 between the direction 541 of the leg massage unit 2300 in FIG. 5(a) and the direction 531 of the front side 642 of the seat portion. Additionally, the angle 552 between the direction 542 of the leg massage unit 2300 in FIG. 5(b) and the direction 530 parallel to the ground may be smaller than the angle 551 between the direction 541 of the leg massage unit 2300 in FIG. 5(a) and the direction 530 parallel to the ground. Such angles 551 and 552 can be measured based on the posture sensor.

When a signal from the posture sensor indicates that the angle formed between the leg massage unit 2300 and the seat portion exceeds a predetermined threshold angle, the control unit 300 may perform a step of controlling the first detection sensor to detect an object. Here, the angle between the leg massage unit 2300 and the seat portion may refer to the angle 554 between the direction 542 of the leg massage unit 2300 and the direction 531 of the front side 642 of the seat portion. The fact that the angle formed between the leg massage unit 2300 and the seat portion exceeds the predetermined threshold angle can indicate that the leg massage unit 2300 is raised. Additionally, it may mean that the leg massage unit 2300 has come out of the receiving portion 610 and the first detection sensor 630 may not detect the leg massage unit 2300. Furthermore, the fact that the angle formed between the leg massage unit 2300 and the seat portion exceeds the predetermined threshold angle can mean that there is a possibility for an object to enter between the body massage unit 2100 and the leg massage unit 2300. FIG. 5(b) illustrates the state where the angle formed between the leg massage unit 2300 and the seat portion exceeds the predetermined threshold angle.

According to various embodiments of the present invention, when the signal from the posture sensor indicates that the angle formed between the leg massage unit and the ground is less than or equal to a predetermined threshold angle, the control unit 300 may perform a step of controlling the first detection sensor to detect an object. The angle formed between the leg massage unit and the ground may refer to the angle 552 between the direction 542 of the leg massage unit 2300 and the direction 530 parallel to the ground. The fact that the angle between the leg massage unit 2300 and the ground is less than or equal to the predetermined threshold angle can indicate that the leg massage unit 2300 is raised. Additionally, it may mean that the leg massage unit 2300 has come out of the receiving portion 610 and the first detection sensor 630 may not detect the leg massage unit 2300. Furthermore, the fact that the angle formed between the leg massage unit 2300 and the ground is less than or equal to the predetermined threshold angle can mean that there is a possibility for an object to enter between the body massage unit 2100 and the leg massage unit 2300. FIG. 5(b) illustrates the state where the angle formed between the leg massage unit 2300 and the ground is less than or equal to the predetermined threshold angle.

Moreover, when the signal from the posture sensor indicates that the angle formed between the leg massage unit 2300 and the seat portion is equal to or less than a predetermined threshold angle, the control unit 300 can perform a step of controlling the first detection sensor not to detect an object. The angle formed between the leg massage unit 2300 and the seat portion can refer to the angle 553 formed between the direction 541 of the leg massage unit 2300 and the direction 531 of the front side 642 of the seat portion. The fact that the angle formed between the leg massage unit 2300 and the seat portion is equal to or less than a predetermined threshold angle can indicate that the leg massage unit 2300 is lowered. Moreover, when the angle formed between the leg massage unit 2300 and the seat portion is equal to or less than a predetermined threshold angle, the leg massage unit 2300 may be within the receiving portion 610, and the first detection sensor 630 may be in a state where the first detection sensor 630 can detect the leg massage unit 2300. In addition, the fact that the angle formed between the leg massage unit 2300 and the seat portion is equal to or less than the predetermined threshold angle can mean that an object cannot be placed between the body massage unit 2100 and the leg massage unit 2300. FIG. 5(a) illustrates the state where the angle formed between the leg massage unit 2300 and the seat portion is equal to or less than the predetermined threshold angle.

As described above, when the signal from the posture sensor indicates that the angle formed between the leg massage unit 2300 and the seat portion is equal to or less than the predetermined threshold angle, the control unit 300 controls the first detection sensor not to detect an object, thereby preventing the first detection sensor from detecting the leg massage unit 2300. Through the above process, the massage device 100 can avoid mistakenly understanding that an object is trapped between the seat portion and the leg massage unit 2300 even when the first detection sensor has detected the leg massage unit 2300.

In various embodiments of the present invention, when the signal from the posture sensor indicates that the angle formed between the leg massage unit 2300 and the ground exceeds a predetermined threshold angle, the control unit 300 can perform a step of controlling the first detection sensor not to detect an object. The angle formed between the leg massage unit 2300 and the ground can refer to the angle 551 formed between the direction 541 of the leg massage unit 2300 and the direction 530 parallel to the ground. The fact that the angle formed between the leg massage unit 2300 and the ground exceeds the predetermined threshold angle can indicate that the leg massage unit 2300 is lowered. Moreover, when the angle formed between the leg massage unit 2300 and the ground exceeds the predetermined threshold angle, since the leg massage unit 2300 may be inside the receiving portion 610, the first detection sensor 630 may be in a state where it can detect the leg massage unit 2300. Furthermore, the fact that the angle formed between the leg massage unit 2300 and the ground exceeds the predetermined threshold angle can mean that an object cannot be placed between the body massage unit 2100 and the leg massage unit 2300. FIG. 5(a) illustrates the state where the angle formed between the leg massage unit 2300 and the ground exceeds the predetermined threshold angle.

Furthermore, the massage device 100 can perform a step 1010 of determining whether the first detection sensor 630 has detected an object. If the signal from the posture sensor indicates that the angle formed between the leg massage unit and the seat portion exceeds the predetermined threshold angle and the first detection sensor 630 detects an object, the control unit 300 can execute a step 1020 of controlling the output of an alarm signal. Additionally, if the signal from the posture sensor indicates that the angle between the leg massage unit and the ground is less than or equal to the predetermined threshold angle and the first detection sensor 630 detects an object, the control unit 300 can perform the step 1020 of controlling the output of the alarm signal. The alarm signal can be output in a text, an image, or a sound, and can be displayed on a screen of the massage device control device 2200.

Along with the step 1020, the control unit 300 can control to halt the movement of the massage device 100. Therefore, the massage device 100 does not cause further damage to an object trapped between the body massage unit 2100 and the leg massage unit 2300.

Additionally, when the signal from the posture sensor indicates that the angle formed between the leg massage unit and the seat portion exceeds the predetermined threshold angle and the first detection sensor detects an object, the control unit 300 can control the leg massage unit 2300 to move parallel to the ground. Moreover, when the signal from the posture sensor shows that the angle between the leg massage unit and the ground is less than or equal to the predetermined threshold angle and the first detection sensor detects an object, the control unit 300 can control the leg massage unit 2300 to move parallel to the ground. That the leg massage unit 2300 moves parallel to the ground means that the leg massage unit 2300 moves such that the user's legs are stretched. Moreover, that the leg massage unit 2300 moves parallel to the ground means that the leg massage unit 2300 moves such that the angle between the leg massage unit 2300 and the seat portion is increased. That is, the leg massage unit 2300 can be raised again. When the leg massage unit 2300 is raised, the space between the leg massage unit 2300 and the body massage unit 2100 can be expanded. Therefore, the massage device 100 can aid in easily releasing an object trapped between the leg massage unit 2300 and the body massage unit 2100.

As previously described, the massage device 100 may further include a massage device control device 2200 for the user to control the massage device. The control unit 300 can control to display the alarm signal on the screen of the massage device control device 2200. Additionally, the control unit 300 can display an alarm release button on the screen of the massage device control device 2200. Furthermore, the control unit 300 can control to deactivate buttons other than the alarm release button. Therefore, the user can only press the alarm release button on the massage device control device 2200, but cannot perform other operations on the massage device 100. In other words, the massage device 100 can continue to remain motionless. The massage device 100 according to the present invention can prevent causing further damage to an object trapped between the body massage unit 2100 and the leg massage unit 2300.

While the massage device control device 2200 has been described above, it is not limited thereto. The massage device control device 2200 can be replaced with an external device as illustrated in FIG. 4. For instance, the massage device control device 2200 can be substituted with an external device that includes a portable electronic device 410 or a wearable device 420.

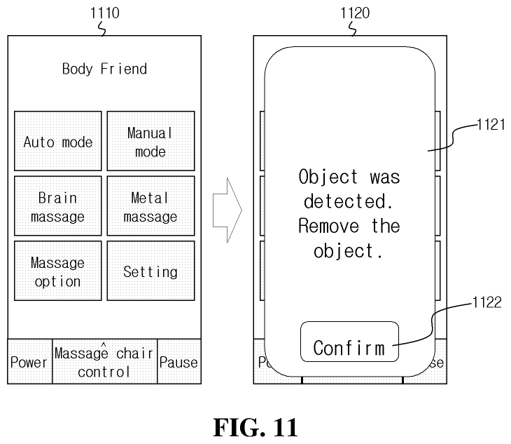

Referring to FIG. 11, the screen displayed on the massage device control device 2200 will be described.

FIG. 11 is a view illustrating a screen output by the massage device according to one embodiment of the present invention.

The screen 1110 is an example of a screen before the output of the alarm signal. The user can input various commands to the massage device 100 using the massage device control device 2200.

As described above, when an alarm signal is output through the aforementioned process, the massage device control device 2200 can display the screen 1120. The screen 1120 displayed by the massage device control device 2200 may include a message 1121 based on the alarm signal. Additionally, the screen 1120 can display an alarm release button 1122.

When the user presses the alarm release button 1122, the massage device 100 can perform an additional step of determining whether at least one of the first detection sensor 630 and the second detection sensor 910 has detected an object. If at least one of the first detection sensor 630 and the second detection sensor 910 has detected an object, the massage device 100 can again display the screen 1120. However, if both the first detection sensor and the second detection sensor have not detected an object, the massage device 100 can resume the operation before the alarm signal was output.

Based on the alarm signal output from the massage device 100, the user can remove the object trapped between the body massage unit 2100 and the leg massage unit 2300. Therefore, both the first detection sensor and the second detection sensor may not detect an object.

Next, if the alarm signal is output based on the first detection sensor, the control unit 300 can perform a step of determining whether at least one of the first detection sensor 630 and the second detection sensor 910 has detected an object. Even if the alarm signal was output based on the first detection sensor, the control unit 300 can verify whether both the first detection sensor 630 and the second detection sensor 910 have detected an object, thereby preventing the massage device 100 from damaging an object, a person, or an animal around the massage device 100. Accordingly, the massage device 100 can operate more safely.

Furthermore, if neither the first detection sensor nor the second detection sensor detects an object, the control unit 300 can perform a step 1030 of determining whether the user has pressed the alarm release button. When the user has pressed the alarm release button, the control unit 300 can perform a step 1040 of controlling the massage device to resume the movement. Additionally, the user can touch the position of the alarm release button displayed on the massage device control device 2200. Accordingly, the massage device 100 can determine that the alarm release button has been pressed. Then, the massage device 100 can resume the movement. Before resuming the movement, the massage device 100 can further perform a step of determining whether at least one of the first detection sensor 630 and the second detection sensor 910 detects an object. The massage device 100 can resume the operation before the alarm signal was output. Furthermore, when the user has pressed the alarm release button, the control unit 300 can control to reactivate other buttons on the screen of the massage device control device. That is, the massage device 100 can display a screen similar to the screen 1110 to control the massage device 100.

However, the present invention is not limited thereto, and the massage device 100 can wait for user input without resuming movement. The user can input commands to the massage device 100 using the massage device control device 2200 or an external device. The massage device 100 can perform an operation corresponding to the input command.

Additionally, when an alarm signal is output, the control unit 300 may first perform the step 1030 of determining whether the user has pressed the alarm release button. Next, when the alarm release button has been pressed by the user, the control unit 300 can perform the step to determine whether at least one of the first detection sensor 630 and the second detection sensor 910 has detected an object. When neither the first detection sensor 630 nor the second detection sensor 910 has detected an object, the massage device 100 may continue the operation performed just before the motion stopped. Furthermore, when neither the first detection sensor 630 nor the second detection sensor 910 detects an object, the control unit 300 can control the other buttons on the screen of the massage device control device to be reactivated. That is, the massage device 100 can display a screen, such as screen 1110, to control the massage device 100.

In addition, when the first detection sensor or the second detection sensor detects an object, or when the alarm release button is not pressed by the user, the massage device 100 can maintain the motionless state and may re-output the alarm signal.

So far, the first detection sensor 630 has been described. Hereinafter, the second detection sensor 910 will be described in more detail. The operation related to the first detection sensor 630 may be similar to the operation related to the second detection sensor 910. Therefore, the description focuses mainly on non-repetitive explanations.

Referring to FIG. 10, the control unit 300 can perform a step 1010 of determining whether the second detection sensor 910 detects an object. When the second detection sensor 910 detects an object on the upper surface of the electric box, the control unit 300 can perform the step 1020 of controlling the output of an alarm signal. Also, when the second detection sensor 910 detects an object on the upper surface of the electric box 510, the control unit 300 can control the massage device 100 to stop the movement.

As described above, the massage device 100 may further include a massage device control device 2200 for the user to control the massage device. The control unit 300 can control the alarm signal to be displayed on the screen of the massage device control device. The control unit 300 can also display an alarm release button on the screen of the massage device control device 2200. The screen displayed on the massage device control device 2200 may be similar to that of FIG. 11. Since FIG. 11 has already been described, repetitive descriptions are omitted. The control unit 300 can control to deactivate buttons other than the alarm release button. Therefore, the user may not control the massage device 100 using the massage device control device 2200.

When an alarm signal is output based on the second detection sensor, the control unit 300 can perform the step of determining whether at least one of the first detection sensor and the second detection sensor has detected an object. Even if an alarm signal is output based on the second detection sensor, by confirming whether both the first detection sensor 630 and the second detection sensor 910 have detected an object, the massage device 100 can prevent the massage device 100 from damaging an object, a person, or an animal around the massage device 100. Accordingly, the massage device 100 can operate more safely.

Additionally, the control unit 300 can perform the step 1030 of determining whether the user has pressed the alarm release button when neither the first detection sensor nor the second detection sensor detects an object. When the alarm release button has been pressed by the user, the control unit 300 can perform the step 1040 of resuming the movement of the massage device. Furthermore, the user can touch the location of the alarm release button displayed on the massage device control device 2200. Accordingly, the massage device 100 can determine that the alarm release button has been pressed. In addition, the massage device 100 can resume the movement of the massage device 100. Before resuming the movement, the massage device 100 may further determine whether at least one of the first detection sensor 630 and the second detection sensor 910 detects an object. The massage device 100 can continue the operation performed prior to the output of the alarm signal. Additionally, when the alarm release button is pressed by the user, the control unit 300 can control to reactivate other buttons on the screen of the massage device control device. That is, the massage device 100 can display a screen, such as the screen 1110, to control the massage device 100.

However, the present invention is not limited thereto, and the massage device 100 can remain stationary, waiting for the user's input. The user can input commands to the massage device 100 using the massage device control device 2200 or an external device. The massage device 100 can perform the operation corresponding to the input command.

In addition, when an alarm signal is output, the control unit 300 can first perform the step 1030 of determining whether the user has pressed the alarm release button. Next, when the alarm release button has been pressed by the user, the control unit 300 can perform the step of determining whether at least one of the first detection sensor 630 and the second detection sensor 910 has detected an object. If neither the first detection sensor 630 nor the second detection sensor 910 detects an object, the massage device 100 can continue the operation performed just before the motion stopped. Furthermore, if neither the first detection sensor 630 nor the second detection sensor 910 detects an object, the control unit 300 can control the other buttons on the screen of the massage device control device to be reactivated. That is, the massage device 100 can display a screen, like the screen 1110, to control the massage device 100.

When the massage device 100 outputs an alarm signal, the user can take necessary actions. For example, the user might need to remove an object located between the body massage unit 2100 and the leg massage unit 2300. Alternatively, the user may remove the object on the electric box 510. As described in FIG. 10, the user must press the alarm release button for the massage device to resume operation. However, even if the user wishes to take the necessary action, it may be difficult for the user to get up from the massage device 100. For instance, the posture of the massage device 100 might make it difficult for the user to rise. To overcome the problem, the massage device 100 can perform additional operations as described below.

The massage device 100 can output an alert sound or alert light based on the user's input or automatically. For instance, the massage device control device 2200 may display an alert output button in addition to the alarm release button 1122. When the user presses the alert output button, an alert sound may be emitted from a speaker, or an alert light may be emitted from a warning light. The speaker or the warning light may be positioned around the first detection sensor 630. Referring to FIG. 6, the speaker or the warning light can be located above, below, in front of, or at the back of the first detection sensor 630. Here, the front and the back may refer to the front and back when the user sits on the massage device 100. When the object between the body massage unit 2100 and the leg massage unit 2300 is a human or an animal, the human or the animal can hear the alert sound or see the alert light and move to a position outside between the body massage unit 2100 and the leg massage unit 2300.

Furthermore, when the massage device 100 performs the step of outputting an alarm signal 1020, the massage device 100 can automatically output an alert sound or alert light. The user might not need to press any additional buttons.

Additionally, the speaker or the warning light can be positioned around the second detection sensor 910. The speaker or the warning light can be located in front, back, left, or right of the second detection sensor 910. Here, the front may refer to the forward direction 920 in FIG. 9. If the object on the electric box 510 is a human or animal, the human or the animal can hear the alert sound or see the alert light and move to a position off the electric box 510.

The massage device 100 may display a forced movement button on the massage device control device 2200. Alternatively, the massage device 100 may include the forced movement button as a physical button. When the user touches or presses the forced movement button, the massage device 100 may be adjusted to be in a posture comfortable for the user to stand up. For example, the leg massage unit 2300 can be lowered. Moreover, the body massage unit 2100 can be raised. Before the massage device 100 moves forcibly, an alert sound or alert light can be emitted for a predetermined period, thereby ensuring time for the object to escape from a danger zone.

Additionally, the massage device 100 can display an emergency button on the massage device control device 2200. When the user presses the emergency button, it may be transferred to the manufacturer's customer service center, a fire department, or a police station. So, the user can communicate with the manufacturer's customer service center, the fire department, or a police officer via text or voice. Therefore, the user can seek assistance to safely escape from the massage device 100.

The massage device 100 of the present invention not only provides a massage to the user comfortably but also may not cause harm to an object, a person, or an animal in the vicinity of the massage device 100. Therefore, the massage device 100 can guarantee safety of the surroundings of the massage device 100.

Various embodiments according to the present invention have been described. It will be understood by those skilled in the art that the present invention may be implemented in a modified form without departing from the essential characteristics of the present invention. Therefore, the disclosed embodiments should be considered in the expository perspective rather than limitative perspective. Therefore, the scope of the present invention is defined not by the detailed description of the invention but by the appended claims, and all differences within the equivalent scope will be construed as being included in the present invention.

Meanwhile, embodiments of the present invention described above may be made as a computer-executable program, and may be implemented in a general-purpose digital computer that operates the program using a computer-readable recording medium. The computer-readable recording medium includes a storage medium, such as a magnetic storage medium (e.g., a ROM, a floppy disk, a hard disk, etc.), or an optical recording medium (e.g., a CD-ROM, a DVD, etc.).

1. A massage device comprising:
a body massage unit for providing a massage to a user's back or thighs, and including a receiving portion for a leg massage unit to accommodate the leg massage unit therein;
an electric box supporting the body massage unit and including a power unit and a control unit; and
the leg massage unit providing a massage to the user's legs, and rotating around a rotary shaft relative to the body massage unit,
wherein the receiving portion of the leg massage unit includes a first detection sensor, which is positioned to face the leg massage unit to detect whether an object exists in the receiving portion of the leg massage unit,
wherein the leg massage unit includes a posture sensor for measuring an angle between the leg massage unit and a seat portion, and
wherein the control unit controls operations of the body massage unit and the leg massage unit.

2. The massage device according to claim 1, further comprising:
a second detection sensor located on the upper surface of the electric box to detect whether an object is placed on the upper surface of the electric box,
wherein the first detection sensor includes at least one of an ultrasonic sensor, an infrared sensor, a laser sensor, or an illumination sensor, and
wherein the second detection sensor includes a tact switch, a capacitive touch sensor, or a pressure sensor.

3. The massage device according to claim 1, wherein when a signal from the posture sensor indicates that the angle formed between the leg massage unit and the seat portion exceeds a predetermined threshold angle, the control unit controls the first detection sensor to detect an object, and
wherein when the signal from the posture sensor indicates that the angle formed between the leg massage unit and the seat portion is less than or equal to the predetermined threshold angle, the control unit controls the first detection sensor not to detect an object.

4. The massage device according to claim 3, wherein when the signal from the posture sensor indicates that the angle formed between the leg massage unit and the seat portion exceeds a predetermined threshold angle and the first detection sensor detects an object, the control unit controls to output an alarm signal and halt the movement of the massage device.

5. The massage device according to claim 4, further comprising:
a massage device control device for the user to control the massage device,
wherein the control unit controls to display the alarm signal on the screen of the massage device control device, and
wherein the control unit controls to output an alarm release button on the screen of the massage device control device, and to deactivate buttons other than the alarm release button.

6. The massage device according to claim 5, wherein when the alarm signal is output, the control unit determines whether the first detection sensor has detected an object,
wherein when the first detection sensor has not detected an object, the control unit determines whether the alarm release button has been pressed by the user, and
wherein when the alarm release button has been pressed by the user, the control unit controls the massage device to resume the movement.

7. The massage device according to claim 6, wherein when the alarm release button is pressed by the user, the control unit controls to reactivate the other buttons on the screen of the massage device control device.

8. The massage device according to claim 3, wherein when the signal from the posture sensor indicates that the angle between the leg massage unit and the seat portion exceeds the predetermined threshold angle and the first detection sensor detects an object, the control unit controls the leg massage unit to move parallel to the ground.

9. The massage device according to claim 2, wherein when the second detection sensor detects an object on the upper surface of the electric box, the control unit controls the massage device to stop the movement.

10. The massage device according to claim 9, further comprising:
a massage device control device for the user to control the massage device,
wherein the control unit controls to display the alarm signal on the screen of the massage device control device, and
wherein the control unit controls to display the alarm release button on the screen of the massage device control device and controls to deactivate other buttons other than the alarm release button.

11. The massage device according to claim 10, wherein when the alarm signal is output, the control unit determines whether both the first and second detection sensors have detected an object,
wherein when neither the first sensor nor the second detection sensor has detected an object, the control unit determines whether the alarm release button has been pressed by the user, and
wherein when the alarm release button has been pressed by the user, the control unit controls the massage device to resume the movement.

12. The massage device according to claim 11, wherein when the alarm release button is pressed by the user, the control unit controls to reactivate the other buttons on the screen of the massage device control device.
